(19) United States
(12) Patent Application Publication
(10) Pub. No.: US 2023/0398857 A1
(43) Pub. Date: Dec. 14, 2023

(54) HEAT EXCHANGE MODULE AND CORRESPONDING MOTOR VEHICLE

(71) Applicant: Valeo Systemes Thermiques, Le Mesnil Saint-Denis (FR)

(72) Inventors: Amrid Mammeri, Le Mesnil Saint Denis Cedex (FR); Gael Durbecq, Le Mesnil Saint Denis Cedex (FR); Erwan Etienne, Le Mesnil Saint Denis Cedex (FR); Kamel Azzouz, Le Mesnil Saint Denis Cedex (FR)

(73) Assignee: Valeo Systemes Thermiques, Le Mesnil Saint-Denis (FR)

(21) Appl. No.: 18/026,049

(22) PCT Filed: Sep. 8, 2021
(86) PCT No.: PCT/EP2021/074684

§ 371 Date: Mar. 13, 2023

(30) Foreign Application Priority Data
Sep. 14, 2020 (FR) 2009282

(51) Int. Cl. B60K 11/04; B60K 11/08

(52) U.S. Cl. CPC B60K 11/04; B60K 11/085

(57) ABSTRACT

The invention relates to a heat exchange module (22) for a motor vehicle (10), comprising: —a housing (32), —at least a first heat exchanger (24) and a second heat exchanger (26) which are arranged in the housing (32), and —a ventilation device comprising at least a first tangential-flow turbomachine (30a) which is configured to move at least a first airflow (F1) intended to pass through the set of heat exchangers (24, 26), and which is arranged downstream of the set of heat exchangers (24, 26) in the direction of flow of the first airflow (F1). According to the invention, the ventilation device comprises at least a second tangential-flow turbomachine (30b) which is configured to move at least one second airflow intended to pass through the first heat exchanger (24), and which is arranged on one side of the housing (32) between the first and second heat exchangers (24, 26) downstream of the first heat exchanger (24) in the direction of flow of the second airflow.

The invention relates to a heat exchange module, particularly to a cooling module for a motor vehicle, having a tangential-flow turbomachine. The invention is particularly applicable to an electric motor vehicle. The invention also relates to a motor vehicle provided with such a heat exchange module.

Motor vehicles, whether of the combustion engine or electric motor type, notably have to discharge the heat generated by their operation, and for this purpose are provided with a heat exchange module, such as a cooling module.

In one known solution, the heat exchange module comprises one or more heat exchangers and a ventilation device designed to set in motion or increase the flow of a flow of air intended to pass through the heat exchangers. The ventilation device thus in particular makes it possible to set in motion a flow of air intended to pass through the heat exchangers, when the vehicle is stationary or moving forward at a low speed.

Moreover, at least one of the heat exchangers is able to contribute to the thermal conditioning, and more particularly to the cooling, of one or more components of the motor vehicle by allowing the dissipation of the heat collected at these components. These are notably electronic and/or electrical components liable to release heat as they operate, such as batteries, and also the motor, an on-board charger, or else a DC-DC converter. This heat may for example be collected by an exchanger of the “chiller” or cooler type.

Specifically, the life and performance of such components, particularly the batteries, are governed by the temperature of the surrounding environment. It is therefore necessary to ensure that these components are kept at a determined temperature during phases in which the motor vehicle is running, which is to say when the batteries are discharging. It is also necessary to ensure cooling of these components during the charging or recharging phases of an electric or hybrid vehicle for example, because these phases are characterized by a heating of these components.

A rapid-charging or fast-charging technique consists in charging the batteries at a high voltage and a high amperage so that they can be charged in a short length of time, for example in a maximum time of twenty minutes. A consequence of this rapid charging is heating, which must be managed.

However, the supply of fresh air to the heat exchange module may not be enough to ensure optimized cooling, notably during phases of rapid charging of an electric or hybrid vehicle for example.

Specifically, the fresh air that enters the heat exchange module via the radiator grille passes through the heat exchangers in succession, such that the air progressively warms up and is at a hotter temperature when it reaches the last heat exchangers in the direction of flow of the airflow. The exchangers situated at the end of the sequence therefore generally experience a fairly high air temperature. This hotter temperature results in lower cooling performance at this or these last heat exchanger(s). These heat exchanges may reach their cooling limit more rapidly than the first heat exchangers.

However, it may be that the last or one of the last heat exchangers has a great need to dissipate heat. Such may be the case for example when this exchanger is a condenser used for dissipating the heat collected from a loop providing temperature control of components liable to generate heat, such as the batteries of an electric or hybrid vehicle. The condenser may notably allow for the dissipation of heat collected by an exchanger such as a cooler also referred to as a chiller.

The reduced cooling performance at the last or one of the last heat exchangers of the heat exchange module means that there will be less cooling notably during the rapid charging phases.

The objective of the invention is to at least partially mitigate these drawbacks of the prior art by providing a heat exchange module having improved thermal performance

To this end, one subject of the invention is a heat exchange module for a motor vehicle, comprising:
a housing,
at least a first heat exchanger and a second heat exchanger which are positioned inside the housing, and
a ventilation device comprising at least a first tangential-flow turbomachine configured to set in motion at least a first airflow intended to pass through the set of heat exchangers, said at least one first tangential-flow turbomachine being positioned downstream of the set of heat exchangers in the direction of flow of the first airflow.

According to the invention, the ventilation device comprises at least a second tangential-flow turbomachine.

Said at least one second tangential-flow turbomachine is configured to set in motion at least a second airflow intended to pass through said at least one first heat exchanger.

Said at least one second tangential-flow turbomachine is positioned on one side of the housing between said first and second heat exchangers, being downstream of said at least one first heat exchanger in the direction of flow of the second airflow.

Such a solution notably makes it possible, thanks to the second tangential-flow turbomachine, and in at least certain operating configurations, to supply the heating exchange module with additional fresh air while having a fairly high airflow rate.

The heat exchange module may also have one or more of the following features described below, considered separately or in combination.

Said at least one second tangential-flow turbomachine is positioned on one side of the housing between said first and second heat exchangers in an axial direction of the heat exchange module. This axial direction is intended to correspond to a longitudinal axis of the motor vehicle when this vehicle is equipped with the heat exchange module.

The two tangential-flow turbomachines are, for example, arranged on sides of the housing that extend in mutually perpendicular planes.

The first tangential-flow turbomachine is, for example, arranged in a rear part of the housing, in the direction of flow of the first airflow, forming a blower housing.

The heat exchange module may comprise at least a first heat exchange unit and a second heat exchange unit, each heat exchange unit comprising one or more heat exchangers, and the second tangential-flow turbomachine is arranged downstream of the first heat exchange unit, between the two units.

The heat exchange module may comprise several second tangential-flow turbomachines.

The tangential-flow turbomachines may be different.

Alternatively, the tangential-flow turbomachines may be similar.

The housing has at least a first air inlet and at least one additional air inlet distinct from the first air inlet.

The additional air inlet is positioned between said at least two heat exchangers on an opposite side of the housing to the side bearing the second tangential-flow turbomachine.

Advantageously, the first tangential-flow turbomachine is configured to set in motion at least a third airflow, intended to enter the housing through the additional air inlet and pass through said at least one second heat exchanger.

Said module may comprise at least one air inlet shutter arranged such that it can move relative to the housing, between a closed position so as to shut off the additional air inlet and an open position for uncovering the additional air inlet.

The housing may comprise a first air outlet downstream of the first tangential-flow turbomachine in the direction of flow of the first airflow.

The housing may comprise a second air outlet downstream of the second tangential-flow turbomachine in the direction of flow of the second airflow.

Said module may comprise at least one air outlet shutter which may be arranged such that it can move relative to the housing between a closed position so as to shut off the second air outlet and an open position for uncovering the second air outlet.

Said at least one shutter is for example mounted with the ability to pivot relative to the housing.

Said module advantageously comprises at least one actuator configured to drive the movement of at least one corresponding shutter between the closed and open positions.

Said module advantageously comprises at least one shut-off panel mounted with the ability to move between a retracted position and a deployed position. In the deployed position, the shut-off panel extends between
on the one hand, said at least one first heat exchanger and
on the other hand, the additional air inlet and said at least one second heat exchanger.

The tangential-flow turbomachines, the set of shutters and the shut-off panel offer various operational configurations of the heat exchange module allowing, depending on the requirements, an influx of fresh air and also a greater airflow rate by comparison with the solutions of the prior art with a tangential-flow turbomachine to the rear of the collection of heat exchangers.

Said module may comprise a drive mechanism, advantageously a motorized drive mechanism, driving the shut-off panel.

The shut-off panel is for example intended to be rolled up around a roller axis.

The shut-off panel, for example a curtain, may be made from a rigid or flexible material.

According to one embodiment, said at least one shut-off panel is configured to be in the deployed position when said at least one air inlet shutter is in the open position uncovering the additional air inlet.

In the deployed position, the shut-off panel is able to delineate, or separate, two air flow paths:
on the one hand, from the first air inlet to the second air outlet, and
on the other hand, from the additional air inlet to the first air outlet.

The module may comprise a frame intended to be positioned at the radiator grille of the motor vehicle. The frame is fitted with a plurality of flaps which are mounted with the ability to move relative to the frame so as to shut off or uncover at least one opening through the frame. At least a first set of flaps may be arranged at a first part of the frame. A second set of flaps, distinct from the first set of flaps, may be arranged at a second part of the frame and is configured to be made to move independently of the first set of flaps.

The first air inlet of the housing is intended to be arranged at a first part of the radiator grille.

The second set of flaps is configured to be made to move according to the position of the air inlet shutter.

The second set of flaps may be arranged in the position that uncovers at least one opening in the second part of the frame, when the air inlet shutter is arranged in the open position uncovering the additional air inlet.

The second set of flaps may be arranged in the position that shuts off said at least one opening in the second part of the frame, when the air inlet shutter is arranged in the closed position shutting off the additional air inlet.

Said module advantageously comprises at least two actuators which are respectively associated with one set of flaps and configured to make the sets of flaps move independently of one another.

Said module may comprise a control unit comprising one or more processing means for commanding actuation of the shutters, of the sets of flaps, of the shut-off panel.

The heat exchange module is preferably intended to be fitted to an electric motor vehicle.

Said module may be a cooling module configured to cool or contribute to the cooling of at least one electronic and/or electrical component of the motor vehicle.

The cooling module is, for example, configured to cool the batteries of an electric or hybrid motor vehicle.

A further subject of the invention is a motor vehicle equipped with at least one heat exchange module as defined hereinabove. This is preferably a motor vehicle with an electric motor.

The vehicle comprises a body having at least one opening defining at least one cooling opening, facing which said at least one heat exchange module may be positioned. The cooling opening may be positioned below the bumper.

In particular, the first air inlet may be arranged facing the cooling opening.

Further advantages and features of the invention will become more clearly apparent from reading the following description, given by way of illustrative and nonlimiting example, and the appended drawings, in which:

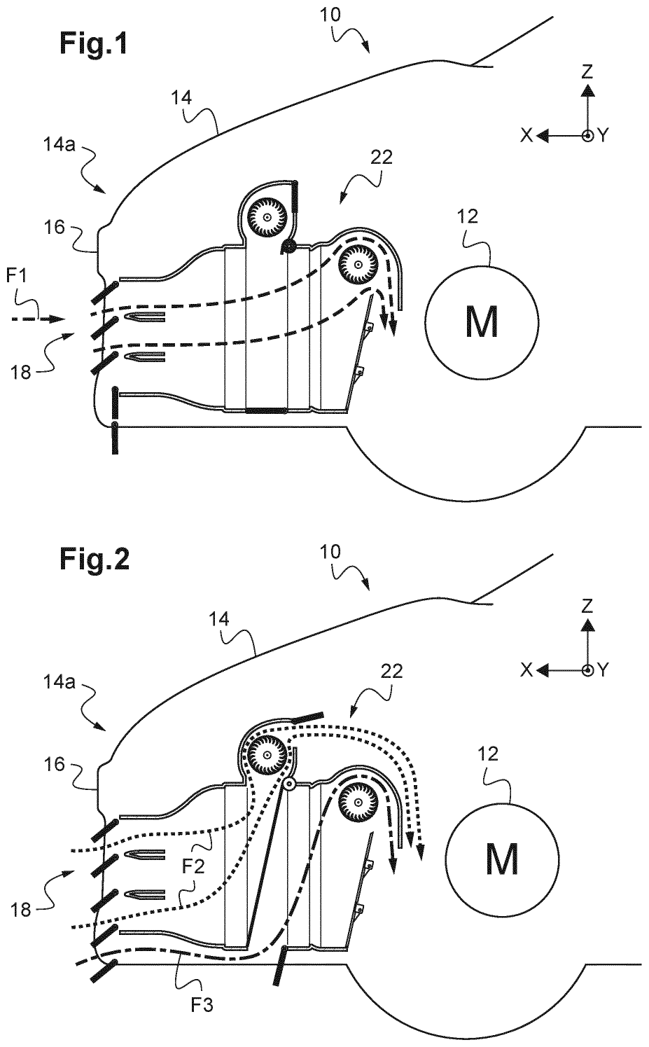

FIG. 1 schematically depicts a front part of a motor vehicle, viewed from the side, equipped with a heat exchange module in a first operational configuration.

FIG. 2 schematically depicts the front part of the motor vehicle, viewed from the side, equipped with the heat exchange module in a second operational configuration.

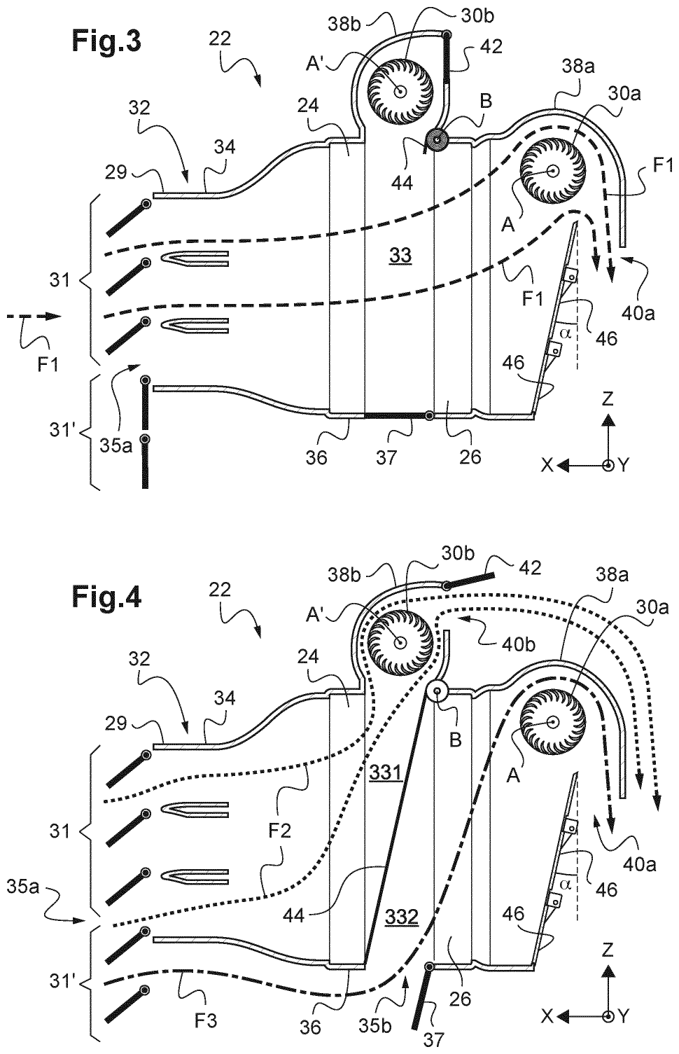

FIG. 3 is a schematic perspective view of the heat exchange module in the first operational configuration.

FIG. 4 is a schematic perspective view of the heat exchange module in the second operational configuration.

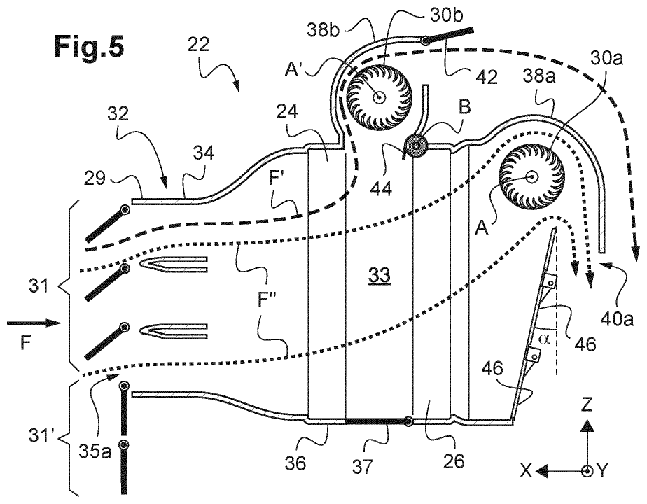

FIG. 5 is a schematic perspective view of the heat exchange module in a third operational configuration.

In these figures, identical elements have the same reference numbers.

The following embodiments are examples. Although the description refers to one or more embodiments, this does not necessarily mean that each reference relates to the same embodiment, or that the features apply only to a single embodiment. Individual features of different embodiments may also be combined or interchanged to provide other embodiments.

In the description, certain elements may be indexed, such as first or second element, for example. The index can simply be used to differentiate and denote elements that are similar but not identical. This indexing does not necessarily imply that one element takes priority over another and such denominations can easily be interchanged without departing from the scope of the present description. This indexing does not necessarily imply an order in time either.

In the present description, “upstream” is intended to mean that one element is placed before another with respect to the direction of flow of the airflow. By contrast, “downstream” is intended to mean that one element is placed after another with respect to the direction of flow of this airflow. The terms front and rear are defined with respect to the direction of forward travel of a motor vehicle.

FIGS. 1 and 2 schematically illustrate the front part of a motor vehicle 10 with a motor, particularly an electric motor 12.

In the figures, a first axis, denoted X, corresponds to a longitudinal axis of the motor vehicle

It also corresponds to the direction of forward travel of the motor vehicle 10. A second axis, denoted Y, is a lateral or transverse axis. Finally, a third axis, denoted Z, is vertical. The axes X, Y, Z are orthogonal in pairs.

The vehicle 10 notably comprises a body 14 defining a front face 14a and a bumper 16 that are supported by a chassis (not shown) of the motor vehicle 10. The body 14 defines a cooling opening 18, that is, an opening through the body 14. The cooling opening 18 is a single opening in the example illustrated. This cooling opening 18 is situated in the lower part, along the vertical axis Z, of the front end 14a of the body 14. In particular, as in the example illustrated, the cooling opening 18 is situated below the bumper 16. A grille can be positioned in the cooling opening 18 to prevent projectiles from being able to pass through the cooling opening 18. A heat exchange module 22 may be positioned in the motor vehicle 10, advantageously facing the cooling opening 18. The grille notably makes it possible to protect this heat exchange module 22.

In particular, the heat exchange module 22 is a cooling module, configured to cool or to contribute to the cooling of at least one component of the motor vehicle 10, notably an electronic and/or electrical component, liable to release heat in operation. The cooling module is, for example, configured to cool or to contribute to the cooling of batteries of an electric or hybrid motor vehicle. In another variant or in addition, the cooling module may be configured to cool/contribute to the cooling of other components such as the motor, an on-board charger, a converter.

In FIGS. 1 and 2, the heat exchange module 22, particularly cooling module, is illustrated in an operational position, i.e. when it is fitted to the motor vehicle 10. FIG. 1 shows the heat exchange module 22 in a first operational configuration with just one air path within the heat exchange module 22, whereas FIG. 2 shows a second operational configuration with two mutually isolated air flow paths within the heat exchange module 22. These configurations are detailed hereinafter.

The heat exchange module 22 is more clearly visible in FIGS. 3 to 5.

It comprises at least two heat exchangers 24, 26. In the example illustrated in FIGS. 3 to 5, the heat exchange module 22 comprises a first heat exchanger 24 and a second heat exchanger 26. Of course, this number of heat exchangers is nonlimiting. The heat exchange module 22 may comprise more heat exchangers according to the configuration desired.

The heat exchange module 22 may for example comprise at least two heat exchange units or two sets of heat exchangers, each heat exchange unit or set of heat exchangers comprising one or more heat exchangers. The heat exchange units may comprise the same number of heat exchangers or a different number of heat exchangers.

The heat exchange module 22 may, by way of nonlimiting example, comprise one or more heat exchangers selected from an evaporator, a condenser, an evaporator-condenser, a radiator, notably a low-temperature radiator. The first heat exchanger 24 may for example be an evaporator-condenser. The second heat exchanger 26 may be a low-temperature radiator.

In the example of FIGS. 3 to 5, the heat exchangers 24, 26 are for example positioned one behind the other in an axial direction of the heat exchange module 22. The heat exchangers 24, 26 are aligned along an axis of alignment which here is parallel or substantially parallel to the longitudinal axis X.

According to the embodiments illustrated, each of the heat exchangers 24, 26 has a parallelepipedal overall shape of which the length extends along the transverse axis Y, the thickness along the longitudinal axis X and the height along the vertical axis Z.

The heat exchange module 22 also comprises a ventilation device. This ventilation device comprises at least a first tangential-flow turbomachine 30a and at least a second tangential-flow turbomachine 30b.

In the examples illustrated in FIGS. 3 to 5, just two tangential-flow turbomachines 30a, 30b have been depicted. This number is nonlimiting. The heat exchange module 22 may comprise more than two tangential-flow turbomachines 30a, 30b.

The first tangential-flow turbomachine 30a is configured to set at least one airflow in motion. As schematically indicated in FIG. 3, the first tangential-flow turbomachine 30a is able to set in motion a first airflow F1 intended to pass through the heat exchangers 24, 26. The first tangential-flow turbomachine 30a is positioned downstream of the heat exchangers 24, 26 in the direction of flow of the first airflow F1.

The first tangential-flow turbomachine 30a comprises, for example, a rotor or turbine (or tangential-flow blower-wheel). The turbine has a cylindrical overall shape. It advantageously comprises one or more stages of blades (or vanes), not illustrated. The turbine is mounted with the ability to rotate about an axis of rotation A, for example parallel or substantially parallel to the transverse axis Y. The first tangential-flow turbomachine 30a also comprises a motor (not depicted) able to drive the turbine in rotation about its axis of rotation A.

The second tangential-flow turbomachine 30b is positioned between the first heat exchanger 24 and the second heat exchanger 26.

More specifically, the second tangential-flow turbomachine 30b is positioned between the first heat exchanger 24 and the second heat exchanger 26 in an axial direction of the heat exchange module 22, which direction is intended to correspond to the longitudinal axis X of the motor vehicle when it is equipped with the heat exchange module 22.

As may be noted from the example of FIGS. 3 to 5, the second tangential-flow turbomachine is not aligned with the heat exchangers 24, 26 but is offset along the vertical axis Z relative to the heat exchangers 24, 26.

The second tangential-flow turbomachine 30b is configured to set at least one airflow in motion.

In particular, with reference to FIG. 4, the second tangential-flow turbomachine 30b is able to set a second airflow F2 in motion. “Second” is used here to distinguish the airflow F2 set in motion by the second tangential-flow turbomachine 30b from the first airflow F1 described previously and set in motion by the first tangential-flow turbomachine 30a. This does not imply that the first airflow F1 takes priority over the second airflow F2.

Unlike the first airflow F1, the second airflow F2 is not intended to circulate through all of the heat exchangers 24, 26. The second airflow F2 is intended to pass through the heat exchanger or exchangers situated in front of the second tangential-flow turbomachine 30b in the direction of the longitudinal axis X. In the example illustrated in FIG. 4, the second airflow F2 is intended to pass through at least the first heat exchanger 24. The second tangential-flow turbomachine 30b is positioned downstream of at least the first heat exchanger in the direction of flow of the second airflow F2. This is possible notably in a configuration in which the internal air duct 33 comprises at least two mutually isolated air flow paths 331, 332, as explained in greater detail hereinafter.

In addition, when the two tangential-flow turbomachines 30a, 30b are in operation, and the internal air duct 33 defines a single air flow path, it is possible for each one to set in motion a part F′ or F″ of an external airflow F, as indicated schematically in FIG. 5. For example, the second tangential-flow turbomachine 30b may set in motion a part F′ of the external airflow F which part is intended to pass through at least the first heat exchanger 24. The first tangential-flow turbomachine 30a may set in motion another part F″ of the external airflow F which part is intended to pass through all of the heat exchangers 24, 26.

The second tangential-flow turbomachine 30b may, in a variant embodiment, be positioned between two heat exchange units, in the direction of the longitudinal axis X. The second tangential-flow turbomachine 30b is, for example, downstream of the first heat exchange unit.

A variant having several second tangential-flow turbomachines 30b interposed between each pair of heat exchangers, on the housing 32, in the direction of the longitudinal axis X, may be envisioned.

The second tangential-flow turbomachine 30b may be similar to or, on the other hand, different than, the first tangential-flow turbomachine 30a. The second tangential-flow turbomachine 30b may comprise a turbine mounted with the ability to rotate about an axis of rotation A′, for example parallel or substantially parallel to the transverse axis Y. In the examples illustrated, the axis of rotation A′ of the turbine of the second tangential-flow turbomachine 30b may be parallel to the axis of rotation A of the turbine of the first tangential-flow turbomachine 30a.

When they are different, the two tangential-flow turbomachines 30a, 30b may, nonlimitingly, be of different sizes, different diameters, different speeds, or have blades with different geometrical shapes.

Furthermore, the tangential-flow turbomachines 30a, 30b are configured in this instance to operate by suction, which is to say that they are able to draw in ambient air and bring it into contact with one or more of the heat exchangers 24, 26.

Advantageously, the first and/or second tangential-flow turbomachine 30a, 30b may be intended to operate when the motor vehicle is running at low speed or is stationary. By contrast, it may be intended not to run when the motor vehicle is at high speed.

Moreover, the heat exchange module 22 may comprise a frame 29. This frame 29 is generally intended to be positioned at the radiator grille of the motor vehicle 10. The frame 29 is fitted with a plurality of flaps 31, 31′ which are mounted with the ability to move relative to the frame 29 so as to shut off or uncover at least one opening through this frame 29.

More specifically, at least a first set of flaps 31 is positioned at a first part of the frame 29, in the example illustrated an upper part along the vertical axis Z, which part is intended to be positioned facing a first part of the grille, when the heat exchange module 22 is fitted to a motor vehicle. The first set of flaps 31 may be situated in a position that allows them to uncover or not uncover at least one opening in the first part of the frame 29.

At least a second set of flaps 31′, which is distinct from the first set of flaps 31, is positioned at a second part of the frame 29, in the example illustrated a lower part along the vertical axis Z, which part is intended to be positioned facing a second part of the grille. The second set of flaps 31′ may be situated in a position that allows them to uncover or not uncover at least one opening in the second part of the frame 29.

The two sets of flaps 31, 31′ are configured to be made to move independently of one another.

The heat exchange module 22 comprises at least two actuators (not depicted) which are respectively associated with one set of flaps 31, 31′ and configured to make the sets of flaps 31, 31′ move independently of one another.

In addition, the heat exchange module 22 comprises at least one housing or cowling 32. In general, the housing 32 is able to house the heat exchanger or exchangers 24, 26 and the first tangential-flow turbomachine 30a.

The first tangential-flow turbomachine 30a is depicted positioned in an upper part, with respect to the vertical axis Z, of the housing 32. Alternatively, the first tangential-flow turbomachine may be positioned in a lower or middle part of the housing 32.

Likewise, the second tangential-flow turbomachine 30b is depicted positioned in an upper part, with respect to the vertical axis Z, of the housing 32. Alternatively, the second tangential-flow turbomachine 30b may be positioned in a lower or middle part of the housing 32.

The housing 32 may be produced as a single part or as multiple parts. In addition, the housing 32 is advantageously produced at least in part from a material that offers acoustic and/or vibrational insulation. It may notably comprise a structural part and an acoustic and/or vibrational insulation part supported by the structural part.

The housing 32 is able to delimit an internal air duct 33 in which air is intended to circulate. The heat exchangers 24, 26 are positioned in this air duct 33.

The housing 32 may comprise a front part 34. This front part 34 is open on one side. It is also intended to be positioned facing the cooling opening, when the heat exchange module 22 is fitted to a motor vehicle.

The frame 29 is positioned at the front part 34 of the housing 32. This frame 29 may be fixed to the housing 32 by any appropriate means.

In general, the housing 32 (made in one or more parts) has at least a first air inlet 35a. The open side of the front part 34 is able to define this first air inlet 35a. The first air inlet 35a is at the first part of the frame 29 and is intended to face the first part of the grille.

The front part 34 is configured to cause an airflow F1, F2, F to enter the heat exchange module 22 and to guide the airflow F1, F2, or part of the airflow F′, F″ as far as one or more heat exchangers 24, 26.

The housing 32 additionally has at least one additional air inlet 35b, distinct from the first air inlet 35a, visible in FIG. 4. More specifically, this additional air inlet 35b is positioned between the two heat exchangers 24, 26. The additional air inlet 35b is positioned between the heat exchangers 24, 26, in the direction of the longitudinal axis X, but on the opposite side to the or a second tangential-flow turbomachine 30b.

The housing 32 may comprise a single additional air inlet 35b, in addition to the first air inlet positioned between the first heat exchanger 24 and the second heat exchanger 26, as in the example illustrated in FIGS. 3 to 5. This additional air inlet 35b allows a supply of fresh air intended to pass through the second heat exchanger 26.

It is also possible to provide more than one additional air inlet 35b. The heat exchange module 22 comprises as many additional air inlets 35b as there are second tangential-flow turbomachines 30b.

The second tangential-flow turbomachine 30b may be on one side of the housing 32 and the additional air inlet 35b on an opposite side of the housing 32. For example, nonlimitingly, the second tangential-flow turbomachine 30b may be positioned on that side of the housing 32 that is intended to face toward the hood of the motor vehicle when it is fitted with the heat exchange module 22, and the additional air inlet 35b may be positioned on the opposite side facing the bottom of the bodyshell, as illustrated in FIGS. 3 to 5. Conversely, the second tangential-flow turbomachine 30b may be positioned on that side of the housing 32 that is intended to face the bottom of the bodyshell, and the additional air inlet 35b on the opposite side intended to face the hood.

The second tangential-flow turbomachine 30b and the additional air inlet 35b may be positioned facing one another, in a manner that is aligned or substantially aligned, along the vertical axis Z.

The ventilation device and, more specifically, the first tangential-flow turbomachine 30a, may be configured to set in motion a third airflow F3, intended to enter the housing 32 through this additional air inlet 35b. “Third” is used here to distinguish the airflow F3 set in motion by the first tangential-flow turbomachine 30a from the first airflow F1 and from the second airflow F2 which were described previously. This does not imply that the first airflow F1 or the second airflow F2 takes priority over the third airflow F3.

Unlike the first airflow F1, the third airflow F3 is not intended to circulate through all of the heat exchangers 24, 26. The third airflow F3 is intended to pass through the heat exchanger or exchangers which are situated behind the additional air inlet 35b in the direction of the longitudinal axis X. In the example illustrated, the third airflow F3 is intended to pass through the second heat exchanger 26.

This is possible notably in a configuration in which the internal air duct 33 comprises at least two mutually isolated air flow paths 331, 332, as schematically indicated in FIG. 4 and explained in greater detail hereinafter.

The housing 32 may also comprise a cowling 36 able to house at least the heat exchangers 24, 26. The additional air inlet or at least one of the additional air inlets 35b may, in an option, be situated on this cowling 36.

In order to allow the opening or closing of an additional air inlet 35b, the heat exchange module 22 comprises at least one shutter, referred to as air inlet shutter 37, associated with the additional air inlet 35b. The heat exchange module 22 comprises one air inlet shutter 37 for each additional air inlet 35b.

There are various conceivable alternative variants for the way in which the additional opening and the air inlet shutter 37 are arranged. The additional air inlet 35b and associated air inlet shutter 37 may be positioned before the last heat exchanger, in the direction of the longitudinal axis X. The additional air inlet 35b and associated air inlet shutter 37 may alternatively be positioned between two heat exchange units.

It is also possible in an embodiment involving more than two heat exchangers, to provide several additional air inlets 35b and several associated shutters 37. An additional air inlet 35b and an air inlet shutter 37 associated therewith, may for example be positioned between each pair of adjacent heat exchangers.

The air inlet shutter 37 is arranged such that it can move with respect to the housing 32. In the examples illustrated in FIGS. 3 to 5, the air inlet shutter 37 is produced in the form of a mobile flap or partition. The air inlet shutter 37 can be moved between a closed position such that it shuts off the additional air inlet 35b, as shown in FIGS. 3 and 5, and an open position such that it uncovers the additional air inlet 35b, as shown in FIG. 4.

The air inlet shutter 37 can be mounted with the ability to pivot with respect to the housing 32 about an axis of pivoting. This axis of pivoting is, for example, parallel or substantially parallel to the axis of rotation A of the first tangential-flow turbomachine 30a and/or A′ of the second tangential-flow turbomachine 30b.

The second set of flaps 31′ is configured to be made to move according to the position of the air inlet shutter 37.

More specifically, the flap or flaps 31′ of the second set are configured to uncover at least one opening in the second part of the frame 29, when the air inlet shutter 37 uncovers the additional air inlet 35b, as illustrated in FIG. 4.

By contrast, the flap or flaps 31′ of the second set are configured to shut off the opening in the second part of the frame 29, when the air inlet shutter 37 is shutting off the additional air inlet as illustrated in FIGS. 3 and 5.

When set in motion by the first tangential-flow turbomachine 30a, the third airflow F3 enters via the second part of the grille, passes through the second set of flaps 31′ which are open, then enters the housing 32 via the additional air inlet 35b, when the associated shutter 37 is in an open position, before passing through the second heat exchanger 26.

Furthermore, the heat exchange module 22 comprises at least one actuator (not visible in the figures) configured to drive the movement of at least one corresponding shutter, such as the air inlet shutter 37, between the closed and open positions. This is, for example, a stepping motor actuator.

When several air inlet shutters 37 are provided, the heat exchange module 22 may comprise at least two actuators each respectively associated with at least one air inlet shutter 37. These actuators are configured to cause the air inlet shutters 37 to move independently of one another. One actuator may be dedicated to each air inlet shutter 37. This allows each additional air inlet 35b to be opened or shut off selectively. It is also conceivable to provide an actuator for a set of air inlet shutters 37, and at least two sets of air inlet shutters 37 can be actuated independently.

Alternatively, an actuator may be configured to drive the movement of all of the air inlet shutters 37 together.

The housing 32 further comprises a rear part. The first tangential-flow turbomachine 30a may be positioned in this rear part of the housing 32. The rear part of the housing 32 may form a first blower housing 38a. This first blower housing 38a houses the first tangential-flow turbomachine 30a. The first blower housing 38a may notably define a blower housing outlet.

The housing 32 may define a second blower housing 38b to house the second tangential-flow turbomachine 30b. The second blower housing 38b may begin starting from that part of the housing 32 that houses the heat exchangers 24, 26, and for example in one option, begin starting from the cowling 36. The second blower housing 38b extends outward from the rest of the housing 32, away from the internal air duct 33 in which the heat exchangers 24, 26 are positioned.

The two tangential-flow turbomachines 30a, 30b are for example positioned, or the blower housings 38a, 38b may be defined, on sides of the housing 32 that extend in mutually perpendicular planes.

The front part 34 is advantageously secured to the cowling 36, to the second blower housing 38b and to the rear part which here forms the first blower housing 38a. At least two of these elements 34, 36, 38a, 38b may also form a single piece.

The housing 32 comprises at least a first air outlet 40a, for example defined by the outlet of the first blower housing 38a in the rear part of the housing 32. The first air outlet 40a is downstream of the first tangential-flow turbomachine 30a in the direction of flow of the first airflow F1 (FIG. 3) or of the third airflow F3 (FIG. 4) or else of part of the airflow F″ (FIG. 5).

The housing 32 additionally comprises at least a second air outlet 40b, for example defined by the outlet of the second blower housing 38b. The second air outlet is downstream of the second tangential-flow turbomachine 30b in the direction of flow of the second airflow F2 (FIG. 4) or else of part of the airflow F′ (FIG. 5).

The second air outlet 40b may be selectively opened or closed. For this purpose, the heat exchange module 22 comprises at least one shutter, referred to as air outlet shutter 42, associated with the second air outlet 40b.

The air outlet shutter 42 is arranged such that it can move with respect to the housing 32. In the examples illustrated in FIGS. 3 to 5, the air outlet shutter 42 is produced in the form of a mobile flap or partition. The air outlet shutter 42 can be moved between a closed position so as to shut off the second air outlet 40b and an open position for uncovering the second air outlet 40b.

The air outlet shutter 42 can be mounted with the ability to pivot with respect to the housing 32 about an axis of pivoting. This axis of pivoting is, for example, parallel or substantially parallel to the axis of rotation A of the first tangential-flow turbomachine 30a or A′ of the second tangential-flow turbomachine 30b.

The heat exchange module 22 comprises at least one actuator (not visible in the figures) configured to drive the movement of at least one corresponding air outlet shutter 42 between the closed and open positions. This is, for example, a stepping motor actuator.

When several air outlet shutters 42 are provided, the heat exchange module 22 may comprise at least two actuators each respectively associated with at least one air outlet shutter 42. These actuators are configured to cause the air outlet shutters 42 to move independently of one another.

One actuator may be dedicated to each air outlet shutter 42. This allows each additional air inlet 35b to be opened or shut off selectively. It is also conceivable to provide an actuator for a set of air outlet shutters 42, and at least two sets of air outlet shutters 42 can be actuated independently.

Alternatively, an actuator may be configured to drive the movement of all of the air outlet shutters 42 together.

Advantageously, the heat exchange module 22 further comprises at least one shut-off panel 44. The shut-off panel 44 is for example a curtain. It may be made from a rigid or flexible material.

This shut-off panel 44 is intended to divide the internal air duct into at least two air flow paths 331, 332 and advantageously isolate them from one another in a fluidtight manner

For this purpose, the shut-off panel 44 is mounted with the ability to move between a retracted position and a deployed position.

In the deployed position, as depicted in FIG. 4, the shut-off panel 44 extends between, on the one hand, the first heat exchanger 24 and, on the other hand, the additional air inlet 35b and the second heat exchanger 26. In particular, the shut-off panel 44 is in the deployed position when the air inlet shutter 37 is uncovering the corresponding additional air inlet 35b.

The deployed shut-off panel 44 thus delineates and separates a first air flow path 331 leading from the first air inlet 35a to the second air outlet 40b, from a second air flow path 332 leading from the additional air inlet 35b to the first air outlet 40a.

More generally, the shut-off panel 44 may extend between, on the one hand, a first heat exchange unit and, on the other hand, the additional air inlet 35b and a second heat exchange unit.

Of course, the heat exchange module 22 may comprise more than one shut-off panel 44. There may be as many shut-off panels 44 as there are additional air inlets 35b, and therefore as there are second tangential-flow turbomachines 30b.

Each shut-off panel 44 is able in this instance to isolate two air flow paths leading from an air inlet to an air outlet.

When more than two air flow paths are delimited, one of the end air flow paths places the first air inlet 35a in fluidic communication with an air outlet downstream of a second tangential-flow turbomachine 30b. The other end air flow path places an additional air inlet 35b in fluidic communication with the first air outlet 40a. The intermediate air flow path or paths may place an additional air inlet 35b in fluidic communication with an air outlet downstream of a second tangential-flow turbomachine 30b.

The shut-off panel 44 is for example intended to be rolled up around a roller axis B. The roller axis B of the shut-off panel 44 is for example transverse to the axis of alignment of the heat exchangers 24, 26. In the example illustrated, the roller axis B is parallel or substantially parallel to the axis of rotation A, or respectively A′, of the first 30a, or respectively of the second 30b, tangential-flow turbomachine. The roller axis B here is parallel to the transverse axis Y.

The heat exchange module 22 may have one or more elements for fixing the shut-off panel or panels 44 to the housing 32.

The heat exchange module 22 may comprise a drive mechanism, advantageously a motorized drive mechanism, driving the shut-off panel 44. The control unit or another may comprise one or more processing means for commanding actuation of the shut-off panel 44, and, therefore, of the corresponding drive mechanism.

The heat exchange module 22 may further comprise a control unit (not depicted). This may, for example, be a computer. This control unit comprises one or more processing means for commanding one or more of the actuators (not depicted) of the sets of flaps 31, 31′, of the shutters 37, 42 and/or of the drive mechanism driving the shut-off panel 44.

Various operational configurations of the heat exchange module 22 are detailed with reference to FIGS. 3 to 5.

FIG. 3 illustrates a first operational configuration, which may be a standard configuration.

In this first operational configuration, the two shutters that are the air inlet shutter 37 and the air outlet shutter 42 are closed and the shut-off panel or curtain 44 is shut away. It is, for example, retracted or furled. In addition, the flaps 31 of the first set uncover the opening in the first part of the frame 29, whereas the flap or flaps 31′ of the second set shut off the opening in the second part of the frame 29.

With such a configuration, just one air flow path is defined in the internal air duct 33, leading from the first air inlet 35a to the first air outlet 40a downstream of the first tangential-flow turbomachine 30a.

When the latter is in operation, the first airflow F1 is set in motion and passes through the first part of the grille of the motor vehicle fitted with the heat exchange module 22, enters the housing 32 through the first air inlet 35a then passes through all of the heat exchangers 24, 26 before leaving the heat exchange module 22 via the first air outlet 40a downstream of the first tangential-flow turbomachine 30a.

In the particular example illustrated, the airflow downstream of the first tangential-flow turbomachine 30a is directed toward the bottom of the bodyshell of the motor vehicle equipped with the heat exchange module 22.

In addition, having the air inlet shutter 37 arranged to shut off the additional air inlet and having the second set of flaps 31′ arranged in such a way as to shut off the opening in the second part of the frame 29 makes it possible to avoid any air, generally hot air, that is discharged downstream of the first tangential-flow turbomachine 30a being drawn back into the housing 32. In other words, this then avoids the fresh air entering the housing 32 becoming “contaminated” with hot air that has already passed through the heat exchangers 24, 26.

FIG. 4 illustrates a second operational configuration, which may be a rapid-charging configuration.

In this second operational configuration, the two shutters that are the air inlet shutter 37 and the air outlet shutter 42 are open. In addition, the two sets of flaps 31, 31′ are arranged in such a way as to uncover the openings in the frame 29.

The shut-off panel or curtain 44 is deployed. It is able to delimit or separate the two air flow paths 331, 332. In the example illustrated, the shut-off panel 44 is deployed between the first heat exchanger 24 and the second heat exchanger 26. The air duct that would have otherwise existed between the first heat exchanger 24 and the second heat exchanger 26 (as described with reference to the first operational configuration) is thus disabled. The shut-off panel 44 makes it possible to isolate the additional air inlet 35b from the first air inlet 35a and from the first heat exchanger 24.

The first air flow path 331 places the first air inlet 35a in fluidic communication with the second air outlet 40b, whereas the second air flow path 332 places the additional air inlet 35b in fluidic communication with the first air outlet 40a. This configuration is nonlimiting. The shut-off panel 44 could be deployed between two heat exchange units or sets of heat exchangers. Several shut-off panels 44 could also be deployed between the heat exchange units or sets of heat exchangers.

Both of the two tangential-flow turbomachines 30a and 30b may be in operation. Thus, each is able to set in motion an airflow intended to pass through the heat exchanger or heat exchangers in the associated air flow path 331, 332.

In the example illustrated, the second tangential-flow turbomachine 30b is able to set in motion a second airflow F2 which is intended to pass through a first part of the grille, enter the housing 32 via the first air inlet 35a, and pass through the first heat exchanger 24 before leaving the housing 32 via the second air outlet 40b. Thus, the second airflow F2 passes through the first heat exchanger 24 without circulating through the second heat exchanger 26.

The first turbomachine 30a is itself able to set in motion a third airflow F3 which is intended to pass through a second part of the grille, enter the housing 32 via the additional air inlet 35b, and pass through the second heat exchanger 26 before leaving the housing 32 via the first air outlet 40a. Thus, the third airflow F3 passes through the second heat exchanger 26 which is situated after the additional air inlet 35b in the direction of the longitudinal axis X, without circulating through the first heat exchanger 24. This configuration is notably advantageous because it allows fresh air to be supplied upstream of the second heat exchanger 26. This makes it possible to optimize the cooling performance of the second heat exchanger 26.

The terms “second” and “third” airflow F2, F3 are used to distinguish the airflows F2, F3 set in motion, notably drawn in, by the two tangential-flow turbomachines 30a, 30b according to the second operational configuration, from the first airflow F1 described with reference to the first operational configuration.

FIG. 5 illustrates a third operational configuration which corresponds to an intermediate mode. This third operational configuration may be advantageous notably when the first heat exchanger 24 requires more cooling. Such may be the case for example when it is an evaporator-condenser. This evaporator-condenser may be configured to dissipate/remove the heat collected at an exchanger of the liquid cooler or water cooler type, also referred to as a chiller, itself configured to dissipate the heat generated by at least one electronic and/or electrical component (such as batteries of an electric motor vehicle).

In this third operational configuration, the air inlet shutter 37 between the two heat exchangers 24, 26 is closed, and conversely the air outlet shutter 42 at the second tangential-flow turbomachine 30b is open. The flaps 31 of the first set uncover the opening in the first part of the frame 29, whereas the flap or flaps 31′ of the second set shut off the opening in the second part of the frame 29.

The shut-off panel 44 is shut away, for example furled or retracted. Both of the two tangential-flow turbomachines 30a, 30b may be in operation. They set in motion an airflow F which enters the housing 32 via the first air inlet 35a. The entirety of the airflow F drawn in passes through the first heat exchanger 24. A first part of the airflow F′, downstream of the first heat exchanger 24, is discharged via the second air outlet 40b. A second part of the airflow F″, downstream of the first heat exchanger 24, passes also through the second heat exchanger 26 before being discharged via the first air outlet 40a.

In a configuration, not depicted, involving more than two heat exchangers, the entirety of the airflow F drawn in would pass through a first set of heat exchangers before the or a second tangential-flow turbomachine 30b. The first part of the airflow F′, downstream of the first set of heat exchangers, would be discharged via the or a second air outlet 40b. The second part of the airflow F″, downstream of the first set of heat exchangers, would pass through a second set of heat exchangers before being discharged via the first air outlet 40a.

If several second tangential-flow turbomachines 30b are provided, then as the airflow progresses through the collection of heat exchangers, a part of the airflow is discharged through each air outlet downstream of a second tangential-flow turbomachine 30b until it is discharged by the first air outlet 40a downstream of the first tangential-flow turbomachine 30a which is the last of the tangential-flow turbomachines in the direction of the longitudinal axis X.

In the particular example illustrated, the airflows downstream of the first tangential-flow turbomachine 30a and of the second tangential-flow turbomachine 30b are directed toward the bottom of the bodyshell of the motor vehicle equipped with the heat exchange module 22.

In a similar way to the first configuration, having the air inlet shutter 37 shutting off the additional air inlet and having the second set of flaps 31′ shutting off the opening in the second part of the frame 29 makes it possible to avoid any air, generally hot air, that is discharged downstream of the tangential-flow turbomachines 30a, 30b being drawn back into the housing 32, thus preventing the fresh air entering the housing 32 being “contaminated” with hot air.

Moreover, according to one particular embodiment, the heat exchange module 22 may further comprise one or more flaps 46 positioned at the rear end of the housing 32 on the opposite side to the first air inlet 35a. These for example are flaps 46 that are mounted with the ability to pivot between an open position that allows at least one airflow to circulate, and a closed position. The open position may be particularly advantageous when the motor vehicle is at high speed and the tangential-flow turbomachines 30a, 30b are not running The closed position may be advantageous when the motor vehicle is at low speed and at least one of the tangential-flow turbomachines 30a, 30b is in operation.

Nonlimitingly, the axis of pivoting of the flaps 46 may be parallel or substantially parallel to the axis of rotation A, or respectively A′, of the first 30a, or respectively of the second 30b, tangential-flow turbomachine. Other configurations are conceivable.

In the closed position, as shown in FIGS. 3 to 5, the flaps 46 are therefore positioned in an inclined plane which in this example forms a nonzero angle α with an axis orthogonal to the axis of alignment of the heat exchangers 24, 26 and to the axis of rotation A of the first tangential-flow turbomachine 30a, which is to say with the vertical axis Z when the heat exchange module 22 is fitted to a motor vehicle. The angle α is preferably comprised between and 20°. This angle α ensures even air distribution over the heat exchangers 24, 26.

Thus, the second tangential-flow turbomachine or turbomachines 30b make it possible to increase the airflow rate and meet a higher demand for fresh air from the heat exchange module.

In particular, by virtue of the tangential-flow turbomachines 30a, 30b, of the set of shutters 37, 42 and of the shut-off panel 44, different operational configurations can be achieved as described hereinabove and these can be managed according to the cooling demand that is required in terms of airflow rate and temperature.

1. A heat exchange module for a motor vehicle, comprising:
a housing; at least a first heat exchanger and a second heat exchanger which are positioned inside the housing; and
a ventilation device comprising:
at least a first tangential-flow turbomachine configured to set in motion at least a first airflow configured to pass through the set of heat exchangers, said at least one first tangential-flow turbomachine being positioned downstream of the set of heat exchangers in the direction of flow of the first airflow, and
at least a second tangential-flow turbomachine configured to set in motion at least a second airflow configured to pass through said at least one first heat exchanger,
wherein the ventilation device is positioned on one side of the housing between said first and second heat exchangers, being downstream of said at least one first heat exchanger in the direction of flow of the second airflow.

2. The heat exchange module as claimed in claim 1, wherein the housing has at least a first air inlet -and at least an additional air inlet distinct from the first air inlet -and positioned between said at least two heat exchangers on an opposite side of the housing to the side bearing the second tangential-flow turbomachine.

3. The heat exchange module as claimed in claim 2, comprising at least one air inlet shutter arranged such that it can move relative to the housing, between a closed position so as to shut off the additional air inlet and an open position for uncovering the additional air inlet.

4. The heat exchange module as claimed in claim 1, wherein:
the housing comprises a first air outlet downstream of the first tangential-flow turbomachine in the direction of flow of the first airflow and a second air outlet downstream of the second tangential-flow turbomachine in the direction of flow of the second airflow, and
at least one air outlet shutter is arranged such that it can move relative to the housing between a closed position so as to shut off the second air outlet and an open position for uncovering the second air outlet.

5. The heat exchange module as claimed in claim 4, wherein said at least one shutter is mounted with the ability to pivot relative to the housing.

6. The heat exchange module as claimed in claim 3, comprising at least one shut-off panel mounted with the ability to move between:
a retracted position, and
a deployed position in which it extends between, on the one hand, said at least one first heat exchanger and, on the other hand, the additional air inlet and said at least one second heat exchanger.

7. The heat exchange module as claimed in claim 6, wherein said at least one shut-off panel is configured to be in the deployed position when said at least one air inlet shutter is in the open position uncovering the additional air inlet.

8. The heat exchange module as claimed in claim 3, comprising a frame configured to be positioned at the radiator grille of the motor vehicle, the frame being fitted with a plurality of flaps which are mounted with the ability to move relative to the frame so as to shut off or uncover at least one opening through the frame, these including:
at least a first set of flaps arranged at a first part of the frame, and a second set of flaps, distinct from the first set of flaps, and arranged at a second part of the frame and configured to be made to move independently of the first set of flaps.

9. The heat exchange module as claimed in claim 8, wherein the second set of flaps is configured to be made to move according to the position of the air inlet shutter, by being:
arranged in the position that uncovers at least one opening in the second part of the frame, when the air inlet shutter is arranged in the open position uncovering the additional air inlet, and
arranged in the position that shuts off said at least one opening in the second part of the frame, when the air inlet shutter is arranged in the closed position shutting off the additional air inlet.

10. A motor vehicle, with an electric motor, comprising: a body having at least one opening defining at least one cooling opening and at least one heat exchange module as claimed in claim 1, positioned facing the cooling opening.
